(19) United States
(12) Patent Application Publication
(10) Pub. No.: US 2024/0149426 A1
(43) Pub. Date: May 9, 2024

(54) GRIP FOR EDGED TOOL

(71) Applicant: U.M. KOGYO INC., HYOGO (JP)

(72) Inventor: SHOZO MIYAWAKI, HYOGO (JP)

(21) Appl. No.: 18/550,359

(22) PCT Filed: Apr. 23, 2021
(86) PCT No.: PCT/JP2021/016460

§ 371 Date: Sep. 13, 2023

(51) Int. Cl. B25G 3/04; B25G 3/14; B26B 3/00

(52) U.S. Cl. CPC B25G 3/04; B25G 3/14; B26B 3/00

(57) ABSTRACT

Provided is a grip for an edged tool in which the operation of fitting split grip bodies can be performed only in a prescribed procedure, thereby reducing variations in fitting, and in which the hand movement when fitting the split grip bodies is in a highly safe direction. A handgrip portion 120 has essential positioning fitting protrusions 123 at the front, split grip bodies 210, 220 have essential positioning fitting recesses 213, 223 at the front, and fitting the essential positioning fitting recesses 213, 223 to the essential positioning fitting protrusions 123 achieves positioning between fitting protrusions and recesses 211, 212, 221, 222 of the split grip bodies and fitting protrusions and recesses 121, 122 of the handgrip portion, while in the case where the fitting protrusions and recesses 211, 212, 221, 222 are first fitted to the fitting protrusions and recesses 121, 122, the fitting between the essential positioning fitting recesses 213, 223 and the essential positioning fitting protrusions 123 is rendered impossible.

### TECHNICAL FIELD

The present invention relates to a grip for an edged tool.

### BACKGROUND ART

Conventionally, a so-called rubber grip is provided as a grip for an edged tool, in which an edged tool body made of metal has its base portion extended to form a handgrip portion, and this handgrip portion is covered with rubber (elastic plastic) or the like. Such a rubber grip can be formed integrally with the edged tool body by insert molding, for example.

There are also provided a large number of grips for an edged tool, in which a grip body is produced in advance as a separate body, and this grip body is mounted on a handgrip portion of an edged tool body, without performing insert molding described above. The grips having the grip body mounted afterward are advantageous in that the production process is simple as compared to insert molding or the like.

However, for the grips requiring fixing screws and the like in securing the grip body to the handgrip portion, there was room for improvement in terms of the number of components and others.

The present inventor previously provided a grip for an edged tool according to Japanese Patent Application Laid-Open No. 2009-56543 as a grip that is completed by fitting a pair of split grip bodies to the handgrip portion of an edged tool body without using screws or the like.

### CITATION LIST

### Patent Literature

Patent Literature 1: Japanese Patent Application Laid-Open No. 2009-56543

### SUMMARY OF INVENTION

### Technical Problem

The grip for an edged tool shown in Patent Literature 1 above is formed solely of a pair of split grip bodies (210), (220) that are mounted on a handgrip portion (120) of an edged tool body (100) to form a grip, without performing insert molding or the like, and without using fixing screws or the like.

On the handgrip portion (120), a plurality of fitting protrusions (121) are formed, and second fitting protrusions (122), (122) are additionally formed on a short side at the distal end of the handgrip portion. On the split grip bodies (210), (220), a plurality of protrusion receiving portions (211), (221) are formed, and second protrusion receiving portions (212), (222) are additionally formed to be fitted with the above-described second fitting protrusions (122), (122).

As the function according to the above configuration, fitting the second protrusion receiving portions (212, 222) to the second fitting protrusions (122, 122) facilitates positioning between the remaining other fitting protrusions (121) and the corresponding remaining other protrusion receiving portions (211, 221).

However, the second fitting protrusions (122) are configured to protrude by only a small amount.

Consequently, the second fitting protrusions (122) and the second protrusion receiving portions (211, 221) do not necessarily have to be fitted together prior to the others, and the fitting operation between the other fitting protrusions (121) and the other protrusion receiving portions (211, 221) can be performed first.

It is of course possible to perform the fitting operation between the other fitting protrusions (121) and the other protrusion receiving portions (211, 221) first, and then perform the fitting between the second fitting protrusions (122) and the second protrusion receiving portions (211, 221).

As described above, the conventional grip for an edged tool disclosed in Patent Literature 1 has a high degree of freedom in the order of performing fitting operations between the fitting protrusions (121, 122) of the handgrip portion 120 and the protrusion receiving portions (211, 212, 221, 222) of the split grip bodies (210, 220). This means that the order of the fitting operation of the split grip bodies (210, 220) would likely vary, which may create subtle variations in the fitting state of the obtained grips.

Furthermore, since the second fitting protrusions (122) having the positioning function are located at the distal end of the handgrip portion (120), when the positioning is performed by fitting the split grip bodies (210, 220) at the second fitting protrusions (122) at the distal end, then the following fitting operation becomes an operation of applying a force from the distal end side of the handgrip portion (120) toward the front.

However, in the case of the mounting operation in which the hand moves in such a manner that the force is applied in a forward direction, a situation would likely occur in which the hand applied with the force accidentally slips from the handgrip portion (120) toward the edged portion (110). Therefore, conventionally, the operation of mounting the split grip bodies (210, 220) had a safety issue as well.

In view of the foregoing, an object of the present invention is to solve the problems of the conventional techniques as described above and to provide a grip for an edged tool obtained by fitting split grip bodies to a handgrip portion of the edged tool body from both sides, in which the operation of fitting the split grip bodies can be performed only in a prescribed procedure, thereby providing a grip of high quality with few variations in fitting, and additionally in which the hand movement for fitting the split grip bodies is in a highly safe direction, thereby securing the safety in the operation of fitting the split grip bodies.

### Solution to Problem

To accomplish the above object, a grip for an edged tool of the present invention has a first feature that it is a grip for an edged tool, the grip being composed of a pair of split grip bodies fitted to a handgrip portion of an edged tool body from a back side and a belly side thereof, wherein
in the handgrip portion having fitting protrusions and recesses provided on each of the back and belly sides, a fitting protrusion at a front of the handgrip portion is configured to be an essential positioning fitting protrusion protruding diagonally forward significantly,
in the pair of split grip bodies each having fitting protrusions and recesses provided corresponding to the fitting protrusions and recesses of the handgrip portion, a fitting recess at a front of the split grip body is configured to be an essential positioning fitting recess protruding diagonally forward significantly, and
in fitting each split grip body to the handgrip portion of the edged tool body, the essential positioning fitting recess in the split grip body is fitted to the essential positioning fitting protrusion of the handgrip portion to thereby achieve positioning between the remaining fitting protrusions and recesses of the split grip body and the remaining fitting protrusions and recesses of the handgrip portion, while in the case where any of the fitting protrusions and recesses of the split grip body is first fitted to any of the fitting protrusions and recesses of the handgrip portion, the fitting between the essential positioning fitting recess of the split grip body and the essential positioning fitting protrusion of the handgrip portion is rendered impossible.

Further, the grip for an edged tool of the present invention has, in addition to the first feature described above, a second feature that the fitting between the essential positioning fitting recess of each split grip body and the essential positioning fitting protrusion of the handgrip portion is achieved by an attachment operation of attaching the essential positioning fitting recess to the essential positioning fitting protrusion in a direction from diagonally forward to diagonally rearward, and the positioning between the remaining fitting protrusions and recesses of the split grip body and the remaining fitting protrusions and recesses of the handgrip portion is achieved by a relative movement of the split grip body in a longitudinal direction of the handgrip portion accompanying the attachment operation.

Further, the grip for an edged tool of the present invention has, in addition to the first or second feature described above, a third feature that in the case where the fitting protrusions and recesses of each split grip body are first fitted to the fitting protrusions and recesses of the handgrip portion, a misalignment occurs between a position of a receiving opening of the essential positioning fitting recess of the split grip body and a position of the essential positioning fitting protrusion of the handgrip portion.

Further, the grip for an edged tool of the present invention has, in addition to any of the first through third features described above, a fourth feature that each split grip body includes a position marker that indicates an attachment starting position in attaching the essential positioning fitting recess to the essential positioning fitting protrusion of the handgrip portion.

Further, the grip for an edged tool of the present invention has, in addition to any of the first through fourth features described above, a fifth feature that each split grip body includes a slip-out preventing portion at the front configured to expand significantly sideward, and the essential positioning fitting recess is formed within a wall thickness of the slip-out preventing portion.

### Advantageous Effects of Invention

According to the grip for an edged tool recited in claim 1, the grip is obtained by fitting a pair of split grip bodies to a handgrip portion of the edged tool body from its back side and belly side.

In the handgrip portion, among the fitting protrusions and recesses provided on each of its back and belly sides, the fitting protrusion located at the front of the handgrip portion is made to protrude diagonally forward significantly, to let it serve as an essential positioning fitting protrusion.

In each of the split grip bodies, among the fitting protrusions and recesses provided corresponding to the fitting protrusions and recesses of the handgrip portion, the fitting recess located at the front of the split grip body is made to protrude diagonally forward significantly, to let it serve as an essential positioning fitting recess.

In fitting the split grip body to the handgrip portion of the edged tool, the essential positioning fitting recess of the split grip body is fitted to the essential positioning fitting protrusion of the handgrip portion, whereby the positioning between the remaining fitting protrusions and recesses of the split grip body and the remaining fitting protrusions and recesses of the handgrip portion is achieved.

First fitting the essential positioning fitting recess of the split grip body to the essential positioning fitting protrusion of the handgrip portion achieves, at the same time, all the positioning between the remaining fitting protrusions and recesses of the split grip body and the corresponding remaining fitting protrusions and recesses of the handgrip portion. Accordingly, the fitting operation of the split grip body can be completed promptly thereafter.

On the other hand, the grip is configured such that if any of the remaining fitting protrusions and recesses of the split grip body is first fitted to any of the fitting protrusions and recesses of the handgrip portion, the fitting between the essential positioning fitting recess of the split grip body and the essential positioning fitting protrusion of the handgrip portion is rendered impossible. This allows the operator to readily recognize that the split grip body cannot be fitted to the handgrip portion unless the operation of fitting the essential positioning fitting recess to the essential positioning fitting protrusion is first performed.

The procedure for fitting the split grip bodies to the handgrip portion requires that the operation of fitting the essential positioning fitting recess at the front of each split grip body to the essential positioning fitting protrusion at the front of the handgrip portion be first performed. So, the split grip body mounting operation starts with the operation of fitting the essential positioning fitting recess to the essential positioning fitting protrusion, and then shifts to the operation of fitting the fitting protrusions and recesses at the rear of the split grip body to the fitting protrusions and recesses at the rear of the handgrip portion. Therefore, standardization of the operation procedure can be easily established, especially at production sites. As the operation procedure becomes always the same, it is possible to eliminate variations in the state of fitting of the split grip bodies and to provide grips of stable quality.

In addition, in the operation of fitting each split grip body, once the essential positioning fitting recess at the front of the split grip body and the essential positioning fitting protrusion at the front of the handgrip portion are first fitted together, the subsequent operation is limited to the fitting between the fitting protrusions and recesses that are located behind the essential positioning fitting protrusion and recess and whose positioning has already been done. Therefore, it is possible to reliably avoid a situation in which a large force is applied toward the front of the handgrip portion and the hand slips toward the edged portion located at the front during the operation. In other words, safety during the fitting operation can be enhanced.

According to the grip for an edged tool recited in claim 2, in addition to the above-described functions and effects obtained by the configuration recited in claim 1, the fitting between the essential positioning fitting recess of each split grip body and the essential positioning fitting protrusion of the handgrip portion is achieved by the attachment operation of attaching the essential positioning fitting recess to the essential positioning fitting protrusion in a direction from diagonally forward to diagonally rearward, and the positioning between the remaining fitting protrusions and recesses of the split grip body and the remaining fitting protrusions and recesses of the handgrip portion is achieved by a relative movement of the split grip body in the longitudinal direction of the handgrip portion associated with that attachment operation.

In other words, the attachment operation of the split grip body enables the essential positioning fitting recess to be fitted to the essential positioning fitting protrusion of the handgrip portion, and the relative movement of the split grip body in the longitudinal direction of the handgrip portion as a result of that attachment operation enables all the positioning between the remaining fitting protrusions and recesses of the split grip body and those of the handgrip portion.

The above-described attachment operation for attaching the essential positioning fitting recess at the front of the split grip body to the essential positioning fitting protrusion at the front of the handgrip portion is an action of applying a force from diagonally forward to diagonally rearward. That is, the component of force in the longitudinal direction of the handgrip portion is a rearward component. Therefore, even if the hand accidentally slips during the attachment operation, the hand will slip toward the rear of the handgrip portion, preventing the hand from slipping out toward the edged portion at the front. In other words, safety in operation can be secured in the attachment operation for attaching the essential positioning fitting recess at the front of the split grip body to the essential positioning fitting protrusion at the front of the handgrip portion.

According to the grip for an edged tool recited in claim 3, in addition to the above-described functions and effects obtained by the configuration recited in claim 1 or 2, it is configured such that in the case where the fitting protrusions and recesses of each split grip body are first fitted to the fitting protrusions and recesses of the handgrip portion, a misalignment occurs between the position of the receiving opening of the essential positioning fitting recess of the split grip body and the position of the essential positioning fitting protrusion of the handgrip portion.

That is, if the fitting protrusions and recesses other than the essential positioning fitting recess are first fitted to the fitting protrusions and recesses other than the essential positioning fitting protrusion, there occurs a misalignment of the position of the receiving opening at the base of the essential positioning fitting recess from the position of the essential positioning fitting protrusion due to the essential positioning fitting recess of the split grip body protruding diagonally forward significantly, hindering the entry of the essential positioning fitting protrusion into the essential positioning fitting recess through the receiving opening.

Therefore, with an improper procedure, a misalignment will occur between the split grip body and the handgrip portion, making it absolutely impossible to fit them together. This leads to further standardization of the operation, and can provide grips for edged tools that are of stable quality and free from fitting failures.

According to the grip for an edged tool recited in claim 4, in addition to the above-described functions and effects obtained by the configuration recited in any of claims 1 to 3, each split grip body includes a position marker that indicates an attachment starting position in attaching the essential positioning fitting recess to the essential positioning fitting protrusion of the handgrip portion.

This allows the operator to readily start the attachment operation by aligning the position marker provided on the split grip body with the essential positioning fitting protrusion of the handgrip portion.

The position marker thus provided facilitates attaching the essential positioning fitting recess, protruding diagonally forward significantly, to the essential positioning fitting protrusion, similarly protruding diagonally forward significantly, to fit them together.

Since the essential positioning fitting protrusion and the essential positioning fitting recess are both configured to protrude diagonally forward significantly, the attachment starting position and the fitted position at the completion of the attachment are misaligned in the longitudinal direction of the handgrip portion. With the provision of the position marker indicating the attachment starting position, even if there is a large misalignment in the longitudinal direction between the attachment starting position and the fitted position after the completion of the attachment, it is readily possible to fit the essential positioning fitting recess of the split grip body to the essential positioning fitting protrusion of the handgrip portion.

According to the grip for an edged tool recited in claim 5, in addition to the above-described functions and effects obtained by the configuration recited in any of claims 1 to 4, each split grip body includes a slip-out preventing portion at the front configured to expand significantly sideward, and the essential positioning fitting recess is formed within a wall thickness of the slip-out preventing portion.

It is therefore possible to synergistically provide the essential positioning fitting recess, which can prevent the hand from slipping toward the edged portion during the assembly operation of the grip for the edged tool, by effectively utilizing the slip-out preventing portion, which prevents the hand from slipping from the grip to the edged portion during the use of the edged tool.

### BRIEF DESCRIPTION OF DRAWINGS

FIG. 1 is an overall perspective view of a hatchet provided with a grip for an edged tool according to an embodiment of the present invention.

FIG. 2 is an exploded perspective view of the grip for an edged tool according to the embodiment of the present invention.

FIG. 3 shows a front view (arranged at the center), a left side view, a right side view, a plan view, and a bottom view of a split grip body, to be fitted to a back side, of the grip for an edged tool according to the embodiment of the present invention.

FIG. 4 shows a front view (arranged at the center), a left side view, a right side view, a plan view, and a bottom view of a split grip body, to be fitted to a belly side, of the grip for an edged tool according to the embodiment of the present invention.

FIG. 5 is a cross-sectional view of the grip for an edged tool according to the embodiment of the present invention.

FIG. 6 is a cross-sectional view of the grip for an edged tool according to the embodiment of the present invention, illustrating the fitting of the split grip bodies.

FIG. 7 is a cross-sectional view of the grip for an edged tool according to the embodiment of the present invention, with (A) to (F) illustrating an exemplary operation of fitting the split grip bodies.

### DESCRIPTION OF EMBODIMENTS

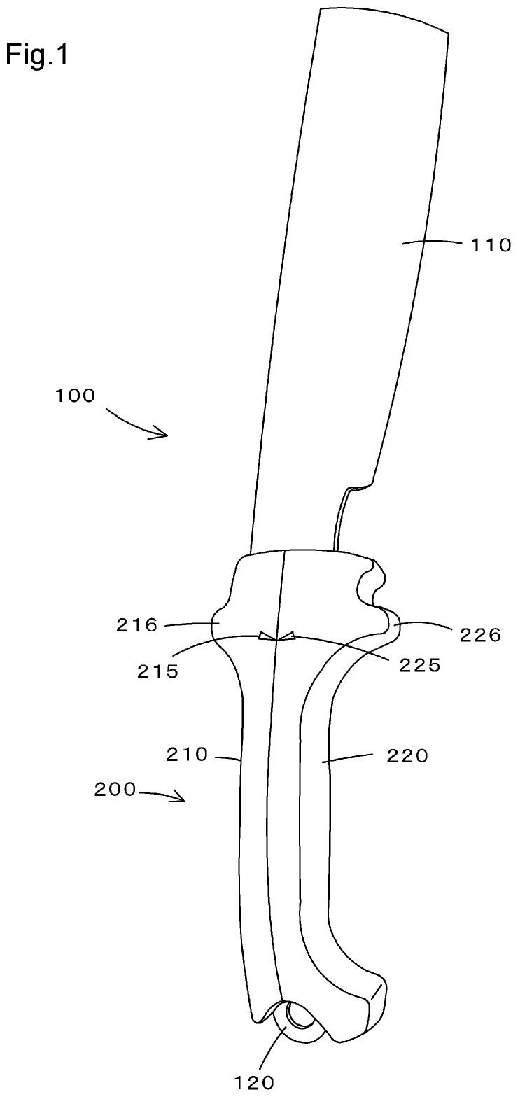

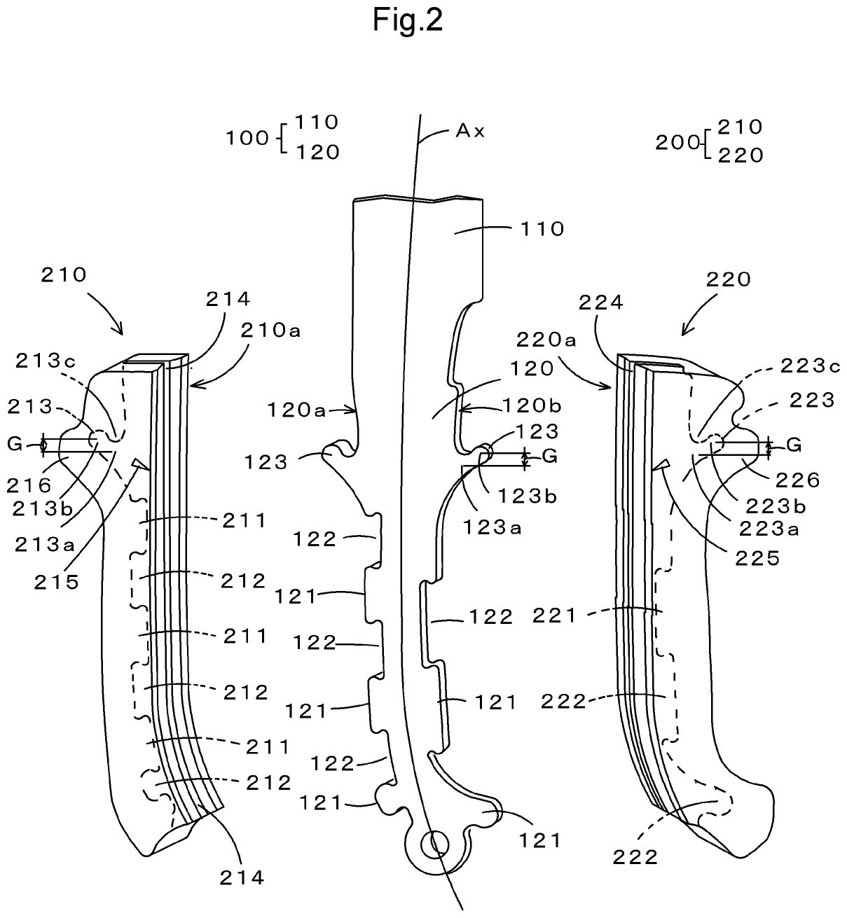

Referring first to FIGS. 1 and 2, the grip for an edged tool of the present invention is composed of a grip body 200 fitted to a rear portion of an edged tool body 100.

The edged tool body 100 includes an edged portion 110 at the front and a handgrip portion 120 at the rear.

The grip body 200 is composed of a pair of split grip bodies 210 and 220 fitted to the handgrip portion 120 of the edged tool body 100, with the split grip body 210 fitted from a back side 120a and the split grip body 220 fitted from a belly side 120b of the handgrip portion 120.

In the above, the back side 120a is a side of the edged tool body 100 provided with no edge, and the belly side 120b is an edged side.

In the present embodiment, the edged tool is a hatchet, and the edged tool body is made of a metallic material.

The edged tool body 100 can of course be configured in a similar manner for edged tools other than the hatchet, such as a sickle, kitchen knife, knife, saw, and the like, and the material used can be, besides metal, a ceramic or other material suitable for such edged tools.

Further, the edged portion 110 is described as one having a cutting edge on one side (belly side). The edged portion 110 may of course be one having cutting edges on both sides. In this case, the above-described back side 120a and belly side 120b would be referred to as one side and the other side, respectively.

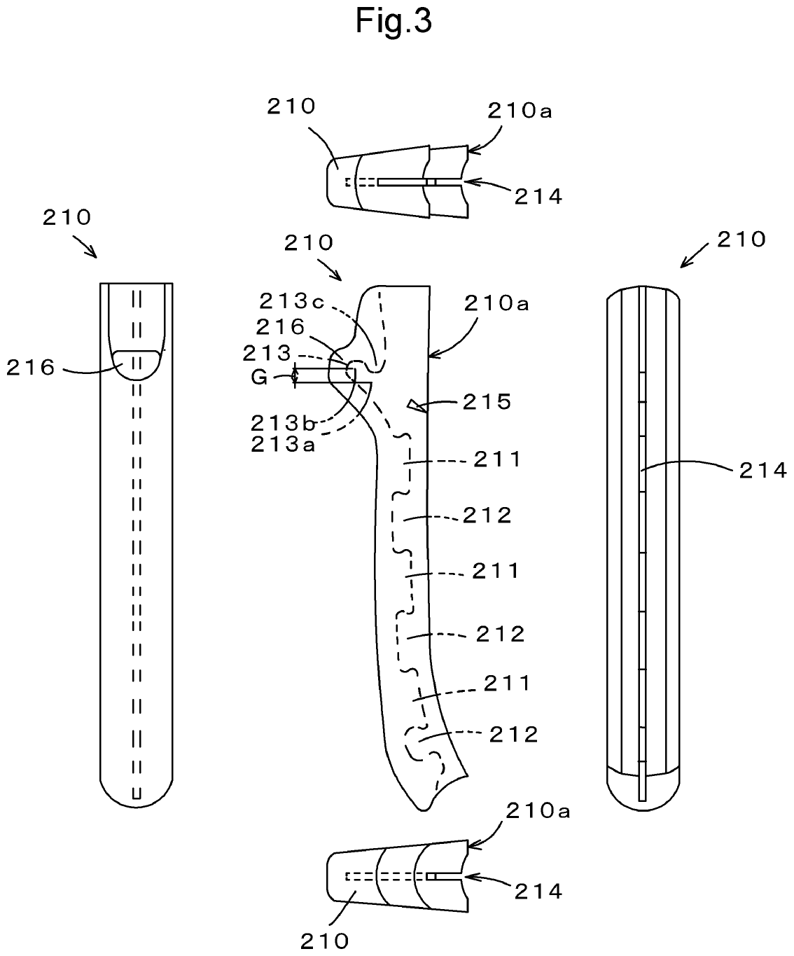

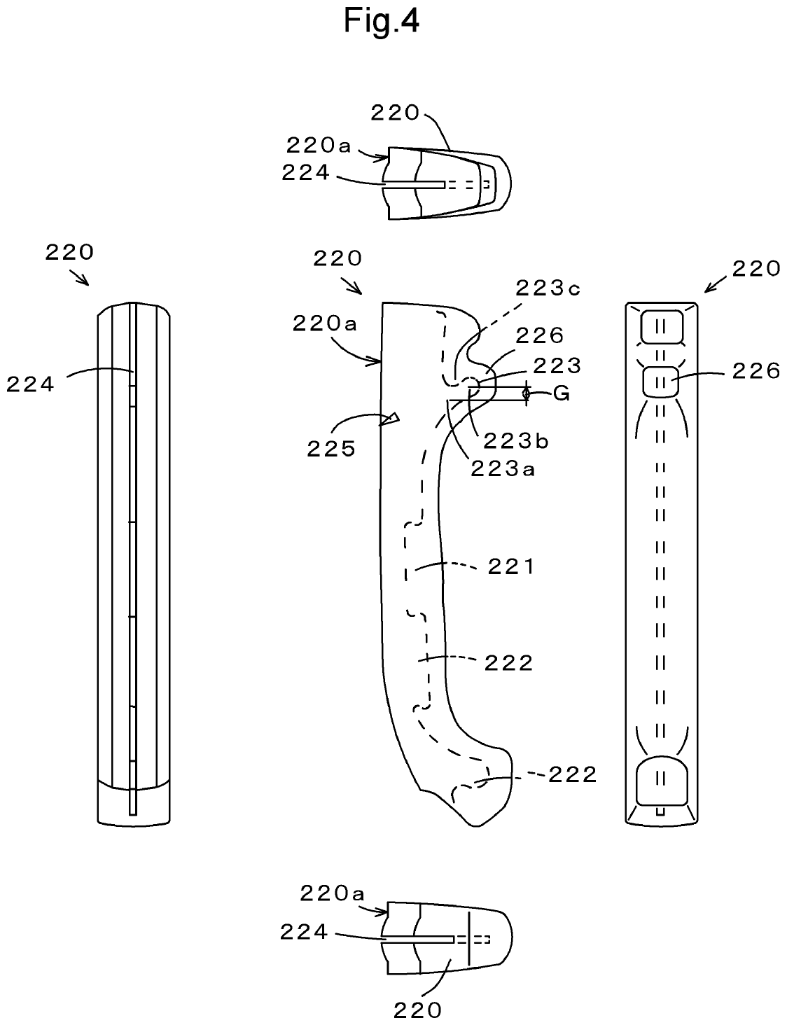

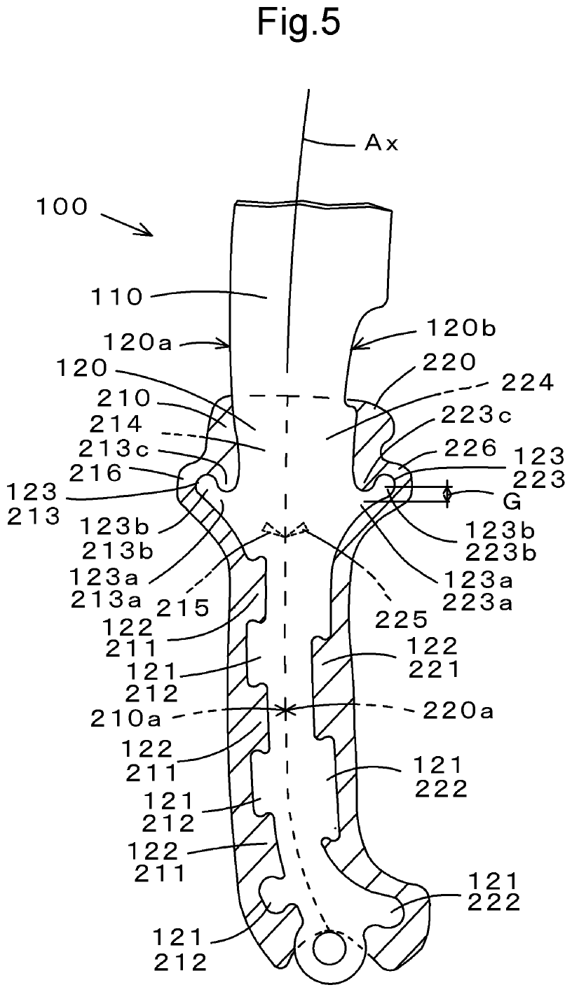

Referring also to FIGS. 3 to 5, the handgrip portion 120 is formed at the rear of the edged tool body 100. In the present embodiment, the handgrip portion 120 is an integrally molded piece continuous with the edged portion 110. However, the handgrip portion 120 may be separably connected to the edged portion 110.

In the present embodiment, the handgrip portion 120 is configured to have a longitudinal axis Ax slightly curved toward the belly side 120b for ease of use. However, it does not necessarily have to be curved.

The handgrip portion 120 has fitting protrusions 121 and fitting recesses 122 formed on both an end face on the back side 120a and an end face on the belly side 120b along its longitudinal direction.

Of the fitting protrusions and recesses 121, 122 formed on the back side 120a of the handgrip portion 120, the fitting protrusion 121 located at the front of the handgrip portion 120 is configured to be an essential positioning fitting protrusion 123 that protrudes diagonally forward significantly.

Similarly, of the fitting protrusions and recesses 121, 122 formed on the belly side 120b of the handgrip portion 120, the fitting protrusion 121 located at the front of the handgrip portion 120 is configured to be an essential positioning fitting protrusion 123 that protrudes diagonally forward significantly.

The pair of essential positioning fitting protrusions 123 and 123 configured in the handgrip portion 120 are actually the fitting protrusions 121 and 121 located at the very front on both sides, configured to serve as the essential positioning fitting protrusions 123 and 123.

The pair of essential positioning fitting protrusions 123 and 123 on the back side 120a and the belly side 120b of the handgrip portion 120 are configured symmetrically, although they do not necessarily have to be symmetrical. Making the protrusions symmetrical facilitates the operation of fitting the pair of split grip bodies 210 and 220 from the back side 120a and the belly side 120b of the handgrip portion 120, and also ensures a good fit condition after completion of the fitting.

The fitting protrusions and recesses 121, 122 and the essential positioning fitting protrusions 123 can be formed, for example, by laser machining, cutting, or other methods.

Referring also to FIGS. 3 to 5, the split grip body 210 on the back side and the split grip body 220 on the belly side constituting the grip body 200 can be made of a material having suitable elasticity, such as a rubber material, elastic resin material, or the like.

The split grip body 210 on the back side and the split grip body 220 on the belly side do not have to be symmetrical in shape.

The pair of split grip bodies 210 and 220 have insertion grooves 214 and 224, respectively, formed at the center of their split surfaces 210a and 220a along the longitudinal direction. The pair of split grip bodies 210 and 220 are fitted together, with their insertion grooves 214 and 224 engaged from the back side 120a and the belly side 120b of the handgrip portion 120. Upon completion of the fitting, the split surfaces 210a and 220a abut against each other.

At the bottom of the insertion grooves 214 and 224 of the split grip bodies 210 and 220, fitting protrusions 211 and 221, fitting recesses 212 and 222, and essential positioning fitting recesses 213 and 223, respectively, are formed.

The fitting protrusions 211 and 221, the fitting recesses 212 and 222, and the essential positioning fitting recesses 213 and 223 provided in the pair of split grip bodies 210 and 220 are formed in correspondence with the fitting protrusions 121, the fitting recesses 122, and the essential positioning fitting protrusions 123 constituted in the handgrip portion 120 of the edged tool body 100.

Of the fitting protrusions 211 and the fitting recesses 212 of the split grip body 210 on the back side 120a, one of the fitting recesses 212 provided at the front of the split grip body 210 serves as the essential positioning fitting recess 213. However, this essential positioning fitting recess 213 differs significantly from the other fitting protrusions 211 and fitting recesses 212 in terms of shape and function.

Similarly, of the fitting protrusions 221 and fitting recesses 222 of the split grip body 220 on the belly side 120b, one of the fitting recesses 222 provided at the front of the split grip body 220 serves as the essential positioning fitting recess 223. However, this essential positioning fitting recess 223 differs significantly from the other fitting protrusions 221 and fitting recesses 232 in terms of shape and function.

The essential positioning fitting recesses 213 and 223 in the pair of split grip bodies 210 and 220 provided on the back side 120a and the belly side 120b of the handgrip portion 120 are formed so as to fit corresponding respectively to the essential positioning fitting protrusions 123 and 123 on the back side 120a and the belly side 120b of the handgrip portion 120 of the edged tool body 100.

The fitting protrusions 121 and the fitting recesses 122 of the handgrip portion 120 are each configured to protrude or recess in a direction approximately perpendicular to the longitudinal direction (axis Ax direction) of the handgrip portion 120.

Similarly, the fitting protrusions 211 and 221 and the fitting recesses 212 and 222 of the pair of split grip bodies 210 and 220 are each configured to protrude or recess in a direction approximately perpendicular to the longitudinal direction (axis Ax direction) of the split grip bodies 210 and 220.

Further, the shapes of the fitting protrusions 121 and fitting recesses 122 in the handgrip portion 120 and the shapes of the one-to-one corresponding fitting recesses 212, 222 and fitting protrusions 211, 221 in the split grip bodies 210, 220 are configured to fit exactly with each other.

The locations of the fitting protrusions 121 and fitting recesses 122 in the handgrip portion 120 and the locations of the one-to-one corresponding fitting recesses 212, 222 and fitting protrusions 211, 221 in the split grip bodies 210, 220 are configured to correspond to each other on a one-to-one basis in the longitudinal direction.

In the above-described manner, the fitting protrusions 121 and fitting recesses 122 in the handgrip portion 120 and the fitting recesses 212, 222 and fitting protrusions 211, 221 in the split grip bodies 210, 220 are all configured to protrude or recess in a direction approximately perpendicular to the longitudinal direction, and their shapes and locations are configured to correspond to each other on a one-to-one basis. This allows the mutual fitting of the fitting protrusions and recesses 121, 122, 211, 221, 212, 222 to be achieved with a simple operation of pressing the grip bodies 210, 220 against the handgrip portion 120 and applying a force thereto from sides (perpendicular to the longitudinal direction) of the handgrip portion 120.

On the other hand, the above-described essential positioning fitting protrusions 123 of the handgrip portion 120 are configured to protrude significantly forward diagonally to the longitudinal direction of the handgrip portion 120.

The corresponding essential positioning fitting recesses 213 and 223 of the split grip bodies 210 and 220 described above are also configured to protrude significantly forward diagonally to the longitudinal direction of the split grip bodies 210 and 220.

By thus configuring each essential positioning fitting protrusion 123 to protrude diagonally forward significantly, there is created a misalignment G between the position of a base portion 123a and the position of a head portion 123b of the essential positioning fitting protrusion 123 in the longitudinal direction (axis Ax direction) of the handgrip portion 120.

Similarly, in each of the essential positioning fitting recesses 213, 223 of the split grip bodies 210, 220, there is created a misalignment G between the position of a receiving opening 213a, 223a at its base and the position of a receiving head 213b, 223b at its head in the longitudinal direction (axis Ax direction) of the split grip body 210, 220.

To put it further, by configuring the essential positioning fitting protrusions 123 and the essential positioning fitting recesses 213, 223 to protrude significantly forward diagonally in the above-described manner, fitting them together is configured to be impossible by merely aligning the positions of the receiving heads 213b, 223b of the essential positioning fitting recesses 213, 223 in the split grip bodies 210, 220 with the positions of the head portions 123b of the essential positioning fitting protrusions 123 in the handgrip portion 120 in the longitudinal direction.

In the present embodiment, the essential positioning fitting recesses 213, 223 of the split grip bodies 210, 220 are each configured to protrude significantly forward diagonally, to thereby create a misalignment G between the receiving head 213b, 223b and the receiving opening 213a, 223a.

It is then configured such that, if the head portions 123b of the essential positioning fitting protrusions 123 of the handgrip portion 120 fail to come to the positions of the receiving openings 213a, 223a at the base of the essential positioning fitting recesses 213, 223 of the split grip bodies 210, 220, the essential positioning fitting recesses 213, 223 cannot be attached to the essential positioning fitting protrusions 123, making it unable to fit them together.

Aligning the essential positioning fitting protrusions 213 (more specifically, the head portions 123b) of the handgrip portion 120 with the receiving openings 213a, 223a of the essential positioning fitting recesses 213, 223 of the split grip bodies 210, 220 makes it possible to attach the essential positioning fitting recesses 213, 223 to the essential positioning fitting protrusions 213 and to allow the head portions 123b of the handgrip portion 120 to enter as far as the receiving heads 213b, 223b of the split grip bodies 210, 220, thereby completing the fitting of the two.

The fitting of the split grip bodies 210, 220 to the handgrip portion 120 is configured as follows. In each of the split grip bodies 210, 220, the essential positioning fitting recess 213, 223 is first attached to the essential positioning fitting protrusion 123 of the handgrip portion 120, and, once the fitting is achieved, the above-described misalignment G is eliminated, enabling all the positioning between the remaining fitting protrusions 211, 221 and fitting recesses 212, 222 of the split grip body 210, 220 and the remaining fitting recesses 122 and fitting protrusions 121 of the handgrip portion 120 to be achieved.

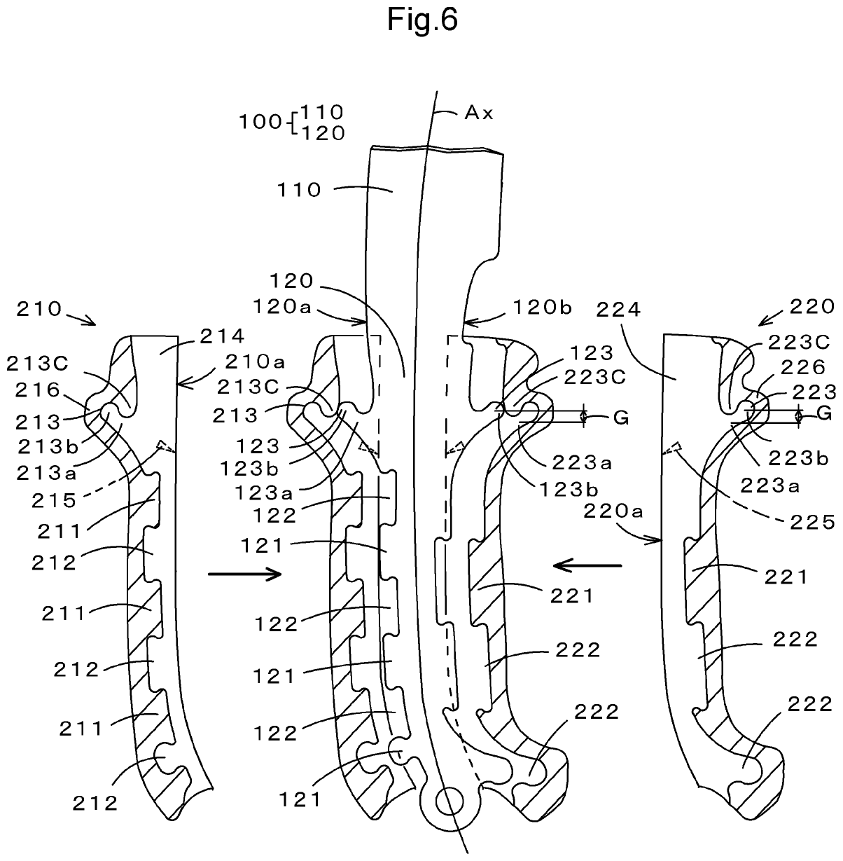

On the other hand, referring also to FIG. 6, it is configured such that, in each split grip body 210, 220, if the fitting protrusions 211, 221 and the fitting recesses 212, 222 of the split grip body 210, 220 are first fitted to the fitting recesses 122 and the fitting protrusions 121 of the handgrip portion 120, the above-described misalignment G between the essential positioning fitting recess 213, 223 of the split grip body 210, 220 and the essential positioning fitting protrusion 123 of the handgrip portion 120 cannot be eliminated, rendering the fitting of the two impossible.

More specifically, in the case where the fitting protrusions 211, 221 and fitting recesses 212, 222 of the split grip body 210, 220 are first fitted to the fitting recesses 122 and fitting protrusions 121 of the handgrip portion 120, a misalignment G of the position of the head portion 123b of the essential positioning fitting protrusion 123 from the position of the receiving opening 213a, 223a of the essential positioning fitting recess 213, 223 occurs, in which case the entry of the essential positioning fitting protrusion 123 (head portion 123b) into the essential positioning fitting recess 213, 223 is prevented by a side wall portion 213c, 223c of the essential positioning fitting recess 213, 223.

The side wall portions 213c, 223c of the essential positioning fitting recesses 213, 223 are walls formed at the bottom of the insertion grooves 214, 224 as the side walls of the recesses due to the shape of the essential positioning fitting recesses 213, 223 protruding diagonally forward significantly. These side wall portions 213c, 223c prevent the entry of the essential positioning fitting protrusions 123 into the essential positioning fitting recesses 213, 223 from the directions perpendicular to the axis Ax.

It should be noted that the fitting described above is actually elastic fitting by the split grip bodies 210, 220 made of an elastic body. In addition, the protrusions and recesses to be fitted are designed such that the fitting cannot be easily released.

The insertion grooves 214, 224 can be configured to be slightly smaller in dimension than the thickness of the handgrip portion 120. This allows the split grip bodies 210, 220 to be firmly engaged with the handgrip portion 120 using their elasticity, and to be securely mounted in a tight fit on the surface of the handgrip portion 120 with their elasticity.

The split grip bodies 210, 220 are provided with position markers 215, 225. The position markers 215, 225 are markers that indicate the attachment starting positions in attaching the essential positioning fitting recesses 213, 223 to the essential positioning fitting protrusions 123, 123 of the handgrip portion 120.

The position markers 215, 225 are represented by triangles in the present embodiment. Each marker indicates the attachment direction by making the direction of the vertex angle of the triangle match the attachment direction of the essential positioning fitting recess 213, 223, i.e., direction from diagonally forward to diagonally rearward.

Of course, the position markers 215, 225 do not necessarily have to be a triangle; they may be other marks as long as they can indicate the attachment position. In a position marker that also indicates the attachment direction, the means for indicating the attachment direction is not particularly limited.

Providing the position markers 215, 225 allows the operator to start attaching the essential positioning fitting recesses 213, 223, even if they protrude diagonally forward significantly, to the essential positioning fitting protrusions 123 correctly by aligning the position markers 215, 225 on the split grip bodies 210, 220 with the essential positioning fitting protrusions 123, 123 in the handgrip portion 120, to thereby fit them together. In other words, even if there is a significant misalignment G in the longitudinal direction between the attachment starting position and the attachment finishing position (fitting completion position), the position markers 215, 225 thus provided enable reliable fitting of the two.

Furthermore, by making the position markers 215, 225 also indicate the attachment directions, the operator can simply attach and move the split grip bodies 210, 220 in accordance with the directions of the markers, whereby the fitting between the essential positioning fitting recesses 213, 223 and the essential positioning fitting protrusions 123 of the handgrip portion 120 can be achieved more easily and more reliably.

The split grip bodies 210, 220 include slip-out preventing portions 216, 226. The slip-out preventing portions 216, 226 are provided for preventing the hand holding the grip from slipping off to the edged portion 110 at the front, which is important for safety in a hatchet or other tool with a sharp edged portion 110.

In the present invention, these slip-out preventing portions 216, 226 are utilized to form the essential positioning fitting recesses 213, 223 within their wall thicknesses. Since the slip-out preventing portions 216, 226 are configured to expand significantly sideward at the front of the split grip bodies 210, 220, they can be arranged, even in the case where the essential positioning fitting recesses 213, 223 are formed to protrude significantly forward diagonally, to well absorb their large dimensions and orientation.

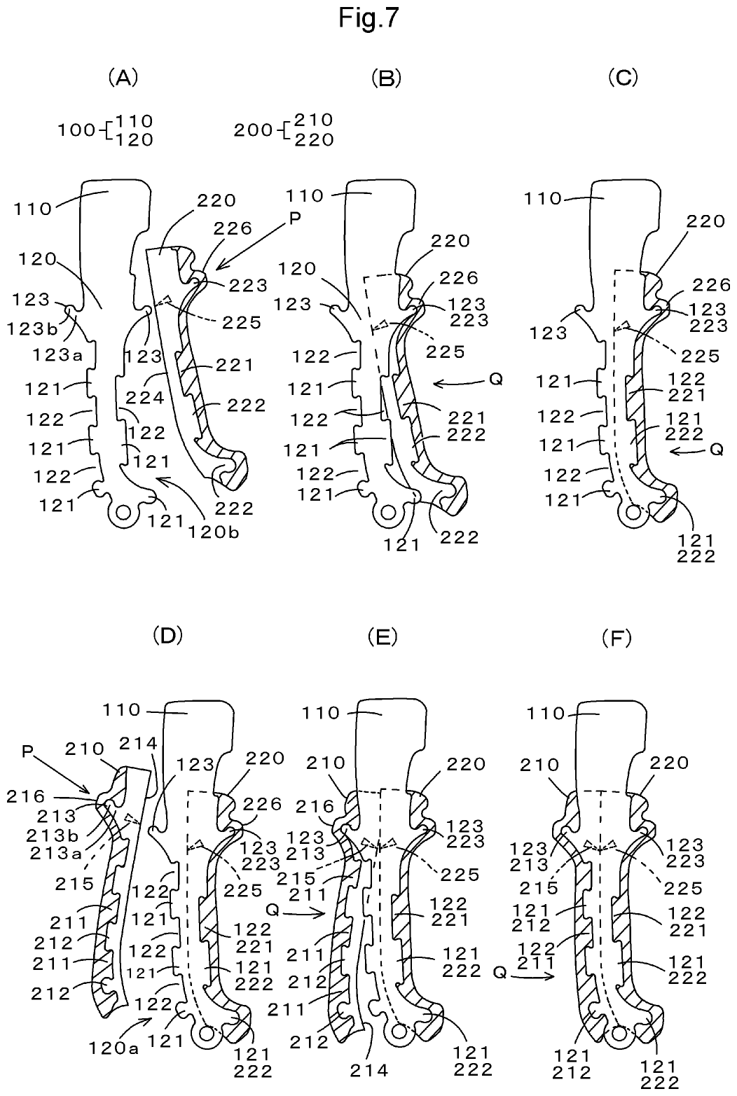

An operation of fitting the split grip bodies 210 and 220 to the handgrip portion 120 will be described with reference to FIG. 7. The fitting operation is performed by fitting one of the split grip bodies 210, 220 first, followed by fitting the other. FIG. 7 shows the case where the split grip body 220 on the belly side 120b of the handgrip portion 120 is fitted first.

Referring first to FIG. 7(A), the split grip body 220 to be fitted to the belly side 120b is picked up, and the position marker 225 of the split grip body 220 is aligned with the essential positioning fitting protrusion 123 on the belly side 120b of the handgrip portion 120. Then, the split grip body 220 is attached to the handgrip portion 120 and moved from diagonally forward to diagonally rearward, as indicated by the arrow sign P. The direction of the arrow P is the same as the direction indicated by the position marker 225 (direction of the vertex angle of the triangle).

Referring next to FIG. 7(B), as the split grip body 220 is moved in the arrow sign P direction according to the position marker 225, the essential positioning fitting recess 223 of the split grip body 220 moves from diagonally forward to diagonally rearward and is engaged with the essential positioning fitting protrusion 123 of the handgrip portion 120, whereby the two portions are fitted together.

At this point, fitting has not yet been made between the fitting protrusions and recesses 221, 222 other than the essential positioning fitting recess 223 of the split grip body 220 and the corresponding fitting protrusions and recesses 121, 122 of the handgrip portion 120.

On the other hand, with the completion of the fitting between the essential positioning fitting recess 223 and the essential positioning fitting protrusion 123, positioning is all completed between the remaining fitting protrusions and recesses 221, 222 of the split grip body 220 and the fitting protrusions and recesses 121, 122 of the handgrip portion 120.

After the completion of the fitting between the essential positioning fitting recess 223 and the essential positioning fitting protrusion 123, the operation proceeds to fitting the fitting protrusion 221 immediately beneath the essential positioning fitting recess 223 to the fitting recess 122 immediately beneath the essential positioning fitting protrusion 123. This is a simple operation, as indicated by the arrow sign Q, of pressing the split grip body 220 against the handgrip portion 120 and applying a force thereto from a side perpendicular to the longitudinal direction (axis Ax direction) of the handgrip portion 120. Since the fitting protrusions and recesses 121, 122 of the handgrip portion 120 and the fitting protrusions and recesses 221, 222 of the split grip body 220 are each configured to protrude or recess in a direction perpendicular to the longitudinal direction (axis Ax direction), the fitting can be completed with such a simple pressing operation of them in the directions perpendicular to the longitudinal direction (axis Ax direction).

Referring to FIG. 7(C), the fitting protrusions and recesses 221, 222 of the split grip body 220 are fitted to the corresponding fitting protrusions and recesses 121, 122 of the handgrip portion 120 sequentially from top to bottom, whereby the fitting of the split grip body 220 is completed.

Then, referring to FIGS. 7(D) and 7(E), the operation moves to fitting the remaining split grip body 210 to the handgrip portion 120 on the back side 120a of the handgrip portion 120.

The fitting of the split grip body 210 is the same as that of the split grip body 220 described above in conjunction with FIG. 7(A). The operation starts with fitting the essential positioning fitting recess 213 of the split grip body 210 to the essential positioning fitting protrusion 123 on the back side 120a of the handgrip portion 120.

The fitting can be easily completed by aligning the position marker 215 of the split grip body 210 with the essential positioning fitting protrusion 123 of the handgrip portion 120 and by attaching the split grip body 210 to the handgrip portion 120 and moving it from diagonally forward to diagonally rearward, as indicated by the arrow sign P. At the same time as the completion of this fitting, the positioning between the remaining fitting protrusions and recesses 211, 212 and the fitting protrusions and recesses 121, 122 is completed.

Referring to FIGS. 7(E) and 7(F), after the completion of the fitting of the essential positioning fitting recess 213 of the split grip body 210 to the essential positioning fitting protrusion 123, fitting of the remaining fitting protrusions and recesses 211, 212 and the fitting protrusions and recesses 121, 122 is performed. This fitting operation is performed by fitting the fitting protrusions and recesses 211, 212 to the corresponding fitting protrusions and recesses 121, 122 sequentially from top to bottom. This fitting operation can be performed easily and smoothly by simply pressing the split grip body 210 from the side perpendicular to the longitudinal direction (axis Ax direction) of the handgrip portion 120.

### INDUSTRIAL APPLICABILITY

The present invention has industrial applicability as a grip for an edged tool, which is applicable to various edged tools.

### REFERENCE SIGNS LIST

100 edged tool body
110 edged portion
120 handgrip portion
120a back side
120b belly side
121 fitting protrusion
122 fitting recess
123 essential positioning fitting protrusion
123a base portion
123b head portion
200 grip body
210 split grip body
210a split surface
211 fitting protrusion
212 fitting recess
213 essential positioning fitting recess
213a receiving opening
213b receiving head
213c side wall portion
214 insertion groove
215 position marker
216 slip-out preventing portion
220 split grip body
220a split surface
221 fitting protrusion
222 fitting recess
223 essential positioning fitting recess
223a receiving opening
223b receiving head
223c side wall portion
224 insertion groove
225 position marker
226 slip-out preventing portion
Ax axis
G misalignment
P arrow sign
Q arrow sign

1. A grip for an edged tool, the grip being composed of a pair of split grip bodies fitted to a handgrip portion of an edged tool body from a back side and a belly side thereof, wherein
in the handgrip portion having fitting protrusions and recesses provided on each of the back and belly sides, a fitting protrusion at a front of the handgrip portion is configured to be an essential positioning fitting protrusion protruding diagonally forward significantly,
in the pair of split grip bodies each having fitting protrusions and recesses provided corresponding to the fitting protrusions and recesses of the handgrip portion, a fitting recess at a front of the split grip body is configured to be an essential positioning fitting recess protruding diagonally forward significantly, and
in fitting each split grip body to the handgrip portion of the edged tool body, the essential positioning fitting recess in the split grip body is fitted to the essential positioning fitting protrusion of the handgrip portion to thereby achieve positioning between the remaining fitting protrusions and recesses of the split grip body and the remaining fitting protrusions and recesses of the handgrip portion, while in the case where any of the fitting protrusions and recesses of the split grip body is first fitted to any of the fitting protrusions and recesses of the handgrip portion, the fitting between the essential positioning fitting recess of the split grip body and the essential positioning fitting protrusion of the handgrip portion is rendered impossible.

2. The grip for an edged tool according to claim 1, wherein the fitting between the essential positioning fitting recess of each split grip body and the essential positioning fitting protrusion of the handgrip portion is achieved by an attachment operation of attaching the essential positioning fitting recess to the essential positioning fitting protrusion in a direction from diagonally forward to diagonally rearward, and the positioning between the remaining fitting protrusions and recesses of the split grip body and the remaining fitting protrusions and recesses of the handgrip portion is achieved by a relative movement of the split grip body in a longitudinal direction of the handgrip portion accompanying the attachment operation.

3. The grip for an edged tool according to claim 1, wherein in the case where the fitting protrusions and recesses of each split grip body are first fitted to the fitting protrusions and recesses of the handgrip portion, a misalignment occurs between a position of a receiving opening of the essential positioning fitting recess of the split grip body and a position of the essential positioning fitting protrusion of the handgrip portion.

4. The grip for an edged tool according to claim 1, wherein each split grip body includes a position marker that indicates an attachment starting position in attaching the essential positioning fitting recess to the essential positioning fitting protrusion of the handgrip portion.

5. The grip for an edged tool according to claim 1, wherein each split grip body includes a slip-out preventing portion at the front configured to expand significantly sideward, and the essential positioning fitting recess is formed within a wall thickness of the slip-out preventing portion.

6. The grip for an edged tool according to claim 2, wherein in the case where the fitting protrusions and recesses of each split grip body are first fitted to the fitting protrusions and recesses of the handgrip portion, a misalignment occurs between a position of a receiving opening of the essential positioning fitting recess of the split grip body and a position of the essential positioning fitting protrusion of the handgrip portion.

7. The grip for an edged tool according to claim 2, wherein each split grip body includes a position marker that indicates an attachment starting position in attaching the essential positioning fitting recess to the essential positioning fitting protrusion of the handgrip portion.

8. The grip for an edged tool according to claim 3, wherein each split grip body includes a position marker that indicates an attachment starting position in attaching the essential positioning fitting recess to the essential positioning fitting protrusion of the handgrip portion.

9. The grip for an edged tool according to claim 2, wherein each split grip body includes a slip-out preventing portion at the front configured to expand significantly sideward, and the essential positioning fitting recess is formed within a wall thickness of the slip-out preventing portion.

10. The grip for an edged tool according to claim 3, wherein each split grip body includes a slip-out preventing portion at the front configured to expand significantly sideward, and the essential positioning fitting recess is formed within a wall thickness of the slip-out preventing portion.

11. The grip for an edged tool according to claim 4, wherein each split grip body includes a slip-out preventing portion at the front configured to expand significantly sideward, and the essential positioning fitting recess is formed within a wall thickness of the slip-out preventing portion.
